(19) United States
(12) Patent Application Publication
(10) Pub. No.: US 2018/0130098 A1
(43) Pub. Date: May 10, 2018

(54) NETWORKED SYSTEM FOR PROCESSING SENSOR DATA AND EXTERNAL DATA FOR AN AD SERVER

(71) Applicant: AKI TECHNOLOGIES, INC., San Francisco, CA (US)

(72) Inventors: Richard Scott Swanson, San Francisco, CA (US); Alvaro Bravo, San Francisco, CA (US); Carlos Mondragon, San Francisco, CA (US); James H. Finn, San Francisco, CA (US)

(21) Appl. No.: 15/343,615

(22) Filed: Nov. 4, 2016

(51) Int. Cl. G06Q 30/02; H04L 29/08

(52) U.S. Cl. CPC G06Q 30/0269; H04L 67/306; H04L 67/42; H04L 67/02; H04L 67/10; H04L 67/22

(57) ABSTRACT

An advertising management system serves advertisements to user devices. Sensor data of the user devices can be analyzed, along with external data indicative of characteristics of a current environment of the user and/or the user device, such as weather, land use, or land type, to determine an audience containing that user. The system can select advertisements to present to that user based on the user's audience. Code embedded in a prior advertisement can be used to gather the sensor data or code provided to application developers, such as in a system development kit, can obtain sensor data. The sensor data can be isolated from the application that executes the code. Sensor data might be distilled to a motion label representing a presumed activity of the user. Analyzing sensor data might include a machine learning process to interpret the sensor data and external data to determine a likely audience.

### FIELD OF THE INVENTION

The present disclosure generally relates to a networked system that gathers sensor data from user devices and more particularly to apparatus and techniques for gathering sensor data from user devices, using machine processing to infer and categorize likely user activities from the sensor data, and provide inferences data to an ad server for serving relevant advertising.

### BACKGROUND

Advertising supports many apps, multimedia providers, news outlets, and the like, and users are accepting of advertising, but often prefer more relevant advertising. Advertisers also often prefer more targeted advertising, especially where advertisers depend on ad brokers or ad exchanges for connecting advertisers to potential customers. Otherwise, advertisers might have their advertisements mostly viewed by an uninterested audience and users of advertising-supported content might find little relevance in the advertising they view.

One approach is to send advertisements based on a user's prior searches or known demographic data. However, that can be limiting.

### SUMMARY

Embodiments of an advertising management system that serve advertisements to user devices that have sensors for sensing movement and other characteristics of the user devices can gather sensor data from the user devices, analyze the sensor data for a user device to determine an audience containing a user of that user device so that the user can be identified as a member of an audience of users sharing a particular profile, select an advertisement to present to that user based on the audience of the user and, following an advertisement request from an application executing on the user device, provide an advertisement selected based on the determined audience. The audience can be determined prior to providing the selected advertisement.

The sensor data can be obtained at times other than just when an advertisement is being presented. For example, code embedded in a prior advertisement data message can be used to gather the sensor data or code provided to application developers, such as in a system development kit, can obtain sensor data. In either case, the sensor data can be obtained without it being available to the application that executes the program code. That program code can be stored in non-transitory computer-readable storage medium available at the user device.

The sensor data might comprise data relating to motion of the user device and be distilled to a motion label representing a presumed activity of the user while using the user device. The motion label might be one of a predetermined set of motion labels. Analyzing the sensor data might include a machine learning process to interpret the sensor data and external data to determine a likely audience. The external data might be data indicative of characteristics of a current environment of the user and/or the user device other than characteristics determined from sensors of the user device, such as weather data for a location indicated by a location sensor or program of the user device, map data indicative of a use of the location, or data indicative of a land type data of the location.

Embodiments might be in the form of a non-transitory computer-readable storage medium having stored thereon executable instructions that, when executed by one or more processors of a computer system, cause the computer system to perform some or all of the steps of such processes. The code provided might include motion collection code, but might also include code for obtaining other sensor data or other data usable to determine appropriate audiences for a user.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is a block diagram of a networked system that correlates user device sensor data with external data to derive a user activity and transmit to the user device selected advertisements based on the derived user activity.

FIG. 2 is a block diagram of another networked system wherein user devices are fitted with program code that collects sensor data that is independent of delivered advertisements.

FIG. 3 is a block diagram of yet another networked system, wherein program code observes motion data over a period of time that is used for selecting advertisements.

FIG. 4 is a schematic of computer-readable elements of memory.

FIG. 5 is a block diagram of a computer processor that might be used for various elements illustrated elsewhere.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

As used herein, a “user device” refers to an electronic device capable of interacting with a person, the “user,” who owns, operates and/or controls the electronic device. The user device is also capable of local computations, storing program code, executing that program code using a processor, presenting content to the user, accepting inputs from the user and sensing physical measurements of the user device, such as its movements, accelerations, rotations and other related measurements. The user device preferably has an ability to communicate with remote servers and other devices.

Communication might be wireless or over wires, with remote servers and other network-connected equipment. A network-connected server might comprise server hardware including a processor that executes server program code and/or database management program code stored in program memory accessible to the processor.

A database management system might maintain databases and/or access storage where databases are stored, to accept data writes and data modifications, as well as responding to requests for data to be read from such databases.

In some aspects, a networked system provides for advertisements to be inserted into slots of apps or web pages. The user device provides sensor data (motion, position, acceleration, location, etc.) that is used to select the appropriate advertisements for applications on that user device. The selection might be done directly from the sensor data or instead the sensor data is used to categorize the user of a user device into an audience and advertisements targeting that audience are served to that user device and similarly situated user devices. An audience is a collection of users that share some determined profile, such as an audience of restaurant enthusiasts, an audience of skiers, an audience of needle workers, an audience of cyclists, an audience of regular library visitors, or the like.

In determining an audience, or audiences for a user of a particular user device, an ad backend server might take sensor data from the user device and combine it with external data and use a machine learning process to interpret the sensor data and the external data to determine a likely audience for that user device. Examples of external data might include weather data (e.g., it was raining that day at this location), land use data (e.g., this land is a ski resort, this land is used for music festivals on this particular day), land type data (this is urban, this is water), etc. As an example, with the user's permission, the user device might provide sensor data to indicate that on a particular day, the user was moving in a dancing way at a particular GPS location and the external data provides that at that date and location, there was a music festival, which the networked system can use to process actions of the user to identify appropriate ads. As another example, based on the sensor data and land use data, the networked system can determine that the user device is owned by a user who is in the skier audience (noting the motion of a person skiing while their GPS location matches ski slopes).

Users give the networked system access to sensors and the user device would collect this sensor data using embedded code that the system operator provides to advertising-supported app developers, such as by providing them with a software development kit (SDK) and having the app developers include SDK-provided code that performs the sensor data processing, while keeping that isolated from the application. In another approach, the sensor data collecting code is included as a JavaScript™ fragment delivered with an advertisement that is executed by a mobile device browser, for example. When supplying the code as part of an advertisement, the code passes through ad exchanges that are supplying advertising-supported apps with advertisements.

Users are associated with audiences and prior data about users can be prestored so that the audiences of a user are known. In other variations, the audience is determined more in real time, where the embedded code is able to observe motion over a period of time, such as a 1 second span to a 10 minute span, and from that observation, an audience can be determined or inferred before sending an advertisement. Audience data and ads served can be stored for later analysis and audience creation. The sensor data can be recorded at the user device for later transmission to an ad backend server. The recorded sensor data might be stored in memory, possibly in a memory space not accessible by other program code on the user device, or otherwise in a manner not accessible by the other program code on the user device.

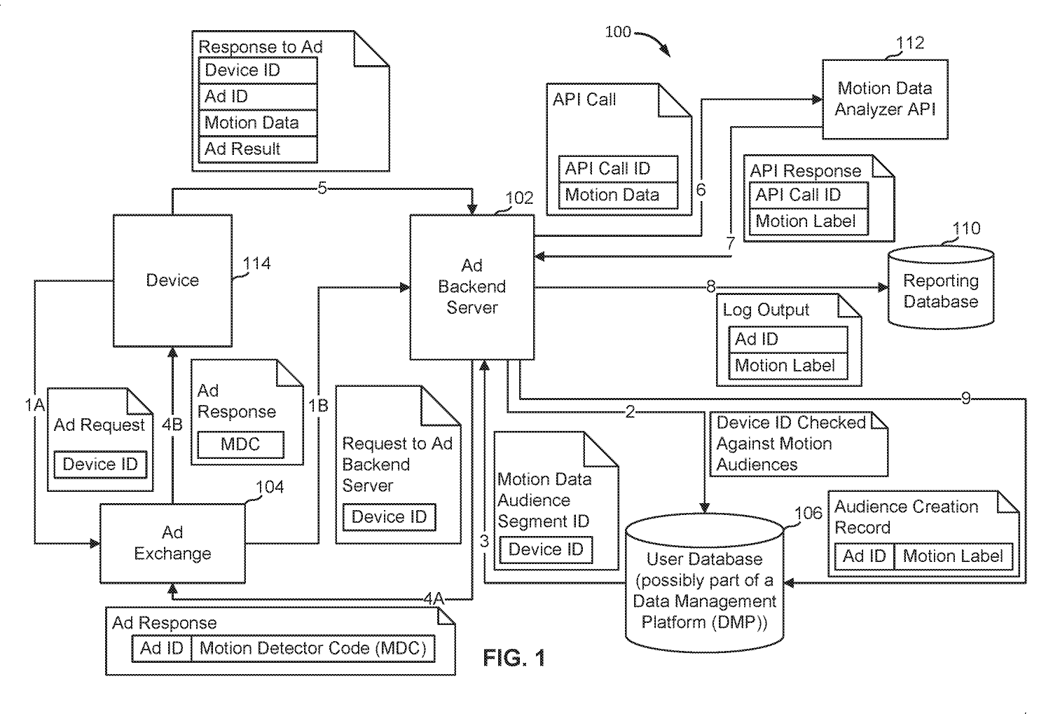

FIG. 1 is a block diagram of a networked system that correlates user device sensor data with external data to derive a user activity and transmit to the user device selected advertisements based on the derived user activity. The networked system might comprise network-connected servers, user devices and databases. In these examples, where only one instance of an object is shown, it should be understood that there might be multiple such instances, unless otherwise indicated.

Derived user activity might be determined from (a) a detection of a movement type of the user (e.g., walking, running, skiing, driving, etc.), (b) a detection of a location of the user device (e.g., in the user's hand, in the user's pocket, resting on a horizontal surface such as a table, etc.), and (c) a detection of a current user activity (e.g., none, handling, typing, etc.). This derived user activity can be determined from raw sensor data from the user device and those determinations can be done on the device, on a central ad backend server that handles other tasks, or can be done using a dedicated service that analyzes sensor data to determine user activity. Derived user activity might be determined based on one-time sensor readings or readings over time.

As shown in FIG. 1, a networked system 100 comprises an ad backend server 102, interfaces to an ad exchange server 104, a user database 106, a reporting database 110 and a motion data analyzer 112 (which might be accessed by ad backend server 102 via an API). Ad backend server 102 might also handle ad campaigns, ad bidding and ad serving. For ad bidding, an app on the user device or an ad exchange in communication with the app might send a conditional request for an ad to ad backend server 102, upon which ad backend server 102 and the app or ad exchange would negotiate for the cost to place an ad. If ad backend server 102 determines that the terms of serving an ad are not agreeable, ad backend server 102 could decline to provide an ad response in response to the ad request. Also shown is a user device 114, which is an end user device. Although only one is shown, it should be understood that networked system 100 can handle many user devices simultaneously.

In a particular process, indicated by the numbered arrows in FIG. 1, data elements are passed among the components of networked system 100. The data elements passed between components can comprise the data indicated and possibly other data. The data might be passed in messages, API calls, writing to shared memory, or other methods of interprocess and/or inter-component communications. A process might start with flow 1, where user device 114 sends a request for an advertisement to an ad exchange server 104. This ad exchange server 104 might be operated independently of networked system 100 and thus networked system 100 will need to take into account constraints imposed by that independence, such as not having control over the structure and operations and data of ad exchange server 104.

When user device 114 requests an advertisement, the request would include a device ID, which would distinguish the requesting user device from other user devices that might also connect to ad exchange server 104. A user device might make a request for an advertisement because the user device is executing an advertiser-supported application or a browser with web pages having slots for advertisements. In some instances, the advertiser-supported application makes requests for advertisements independent of the design of the application. For example, many different advertiser-supported applications might use the same ad exchange server. In such cases, the request in flow 1 might also identify the advertiser-supported application, so that the ad exchange server can take that information into account in selecting the ad to serve up and also to track credits to application providers.

The flow 1 comprises two parts, a flow 1A where the ad request is sent to an interface for ad exchange server 104 and a flow 1B where the ad request is sent from ad exchange server 104 to ad backend server 102.

In flow 2, ad backend server 102 sends a query on user database 106 to determine if there are records for the user device identified in the request in flow 1. If not, records might be created. If there are records for that user device, the records would include details of one more motion audiences associated with the user device. An association of a user device (or some anonymized reference to the user device) might be formed from a history of motion of that user device. The mapping of users based on motion and other information to audiences might be done based on a set of rules that are stored in computer-readable form. For example, it might have been determined that beer ads are more frequently clicked during hotter weather whereas hot tea sells better during colder weather. Thus the ruleset might contain computer-readable rules such as “if user's current outdoor temp is less than X, put them in the tea drinking audience” and “if user's current outdoor temp is more than X, put them in the beer drinking audience.” These rules might be obtained empirically from human observation and encoded into the ruleset or some rules might occur from data analysis.

Based on previously gathered sensor data, a profile of the user of the user device is made by mapping raw sensor data to motion categories or labels, and possibly using external data as well. For example, ad backend server 102 might provide motion data analyzer 112 with sensor-based raw motion data that motion data analyzer 112 returns as being characterized as skiing motions, so then ad backend server 102 would store with the user record for that device in user database 106 a field indicator indicating that the user device is in the “skier” audience comprising users IDs associated with user devices that provided similar data, such as sensor data indicating hours of side-to-side movements during time periods that overlap time periods during which the location sensors (GPS, etc.) of the user devices reported locations that the networked system externally (outside of the user devices) determined are locations corresponding to ski resorts.

In flow 3, ad backend server 102 obtains audience segment data from the response to the query of user database 106 in flow 2. The reply data indicates the audience segments for the queried user ID. In flow 4, ad backend server 102 sends a message to user device 114 (via ad exchange server 104, hence the flows 4A and 4B) comprising an advertisement in the form of electronic content. This flow 4 appears to user device 114 as a response to the request in flow 1. Ad backend server 102 selects the ad to send based on processes that determine, based on campaign rules stored in computer-readable form that selects among possible ads and the one or more audiences that the user device belongs to. Under some conditions, ad backend server 102 might determine that it does not want to incur costs associated with an ad placement and does not return an ad. In those cases, the ad response in flow 4A might be a message indicating that an ad is not going to be supplied.

The message in flow 4 includes the advertisement content, which might be text, an animation, video, interactive program, etc. and the message also contains a snippet of code for motion measuring. This snippet might be an HTML/MRAID code portion that contains JavaScript™ code. As an ad is provided to the user device, the user device will execute the code.

Once the advertisement message is received by user device 114, user device 114 can use the advertisement, such as by placing it into an advertising slot of the requesting app, where the result might be a banner advertisement inside the requesting app. In the process of using the advertisement, user device 114 will execute the motion measuring snippet of code. The code snippet then causes a message to be transmitted, as flow 5, to ad backend server 102. That message contains the user device identifier, the sensor data (motion data and possibly other sensor data) when the advertisement was being displayed, and an identifier of the advertisement.

The “ad result” data element might be a metric representing whether the ad was clicked on, which can be representative of, or a proxy for, a measure of engagement. The sensor data might be stored as a hash table that is then compiled into a protocol buffer or other data structure for serializing structured data. The data structure containing the sensor data might be created by user device 114 using the JavaScript™ portion of the ad or it could also be generated by SDK code in user device 114.

Flow 6 might be an API call with arguments of an API call ID, motion data, and an ad result record. The data sent to motion data analyzer 112 might be in the form of an HTTP request, including a basic hash table, possibly compiled into a protocol buffer or other data structure for serializing structured data. In response to the API call made by ad backend server 102, motion data analyzer 112 responds with a response record to ad backend server 102 containing movement data as well as the originally supplied API call ID argument, which might not be needed if ad backend server 102 can otherwise match up API calls and API responses.

In flow 8, ad backend server 102 sends the content of the API call response, or at least the motion data and the ad ID, to reporting database 110. Reporting database 110 can be used to generate reports for customers, understand how each ad and ad campaign performed and can be used for the data science aspect to further optimize ad engagement. Instead of storing raw sensor data, motion might be stored as a label, such as a selection from an enumerated list. Reporting database 110 might store, for various labels, corresponding click-through rates (CTR). The rates might be for a recent period of time, as shown in the example of Table 1.

TABLE 1

| | | | | | Change over |
|---|---|---|---|---|---|
| Category | Action | Label | Count | CTR | baseline CTR |
| Discerned | Walking | WALK | 1000 | 2.3% | 130% |
| User | Running | RUN | 3500 | 1.2% | 20% |
| Motions | Lying Down | LYING | 3000 | 1.6% | 60% |
| Discerned | Typing | TYPE | 1800 | 1.45% | 45% |
| Device | Device on Table | REST | 900 | 0.1% | −90% |
| Activity | Device in Hands | HANDL | 1250 | 4.3% | 330% |
| | Music Playing | MUSIC | 600 | 0.7% | −30% |
| Combined | Hands and Typing | COMB-1 | 721 | 2.2% | 120% |
| Detections | Walking and Typing | COMB-2 | 145 | 2.5% | 150% |
| | Music Playing and Running | COMB-3 | 120 | 2.15% | 115% |
| | Music Planning and Lying Down | COMB-4 | 450 | 0.3% | −70% |

In Table 1, a CTR of 1.00% is used, but other numbers might work instead. The count might be the total number of instances of an ad being served while the user device was reflecting a given label and the CTR for that label might be the percentage of those instances where the user further engaged with the ad, such as be clicking through the ad. From the change over the baseline CTR, promising labels and their corresponding ads can be determined.

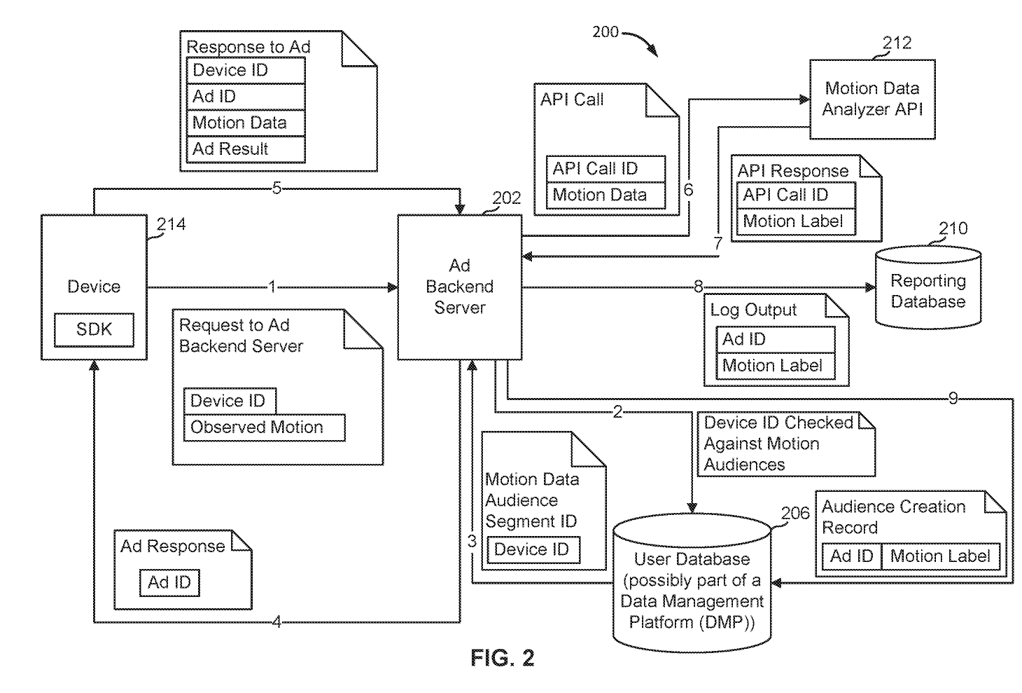

FIG. 2 is a block diagram of another networked system 200 wherein user devices are fitted with program code that collects sensor data that is independent of delivered advertisements. In the embodiment of FIG. 2, a networked system 200 comprises an ad backend server 202, a user database 206, a reporting database 210 and a motion data analyzer 212. For getting ads, a published app might make a request to ad backend server 202 using code provided by an SDK for that purpose to the app developer. The app (via the SDK code) might send a conditional request for an ad to ad backend server 202, upon which ad backend server 202 provides an ad response in response to the ad request. User device 214 executes the app that includes the SDK code. Although only one is shown, it should be understood that networked system 200 can handle many user devices simultaneously.

As in FIG. 1, the numbered arrows in FIG. 2 indicate flows wherein data elements are passed among the components of networked system 200. A process might start with flow 1, where the app having the SDK code makes an ad request and provides previously recorded observed motion. The request would include a device ID as well.

In flow 2, ad backend server 202 sends a query on user database 206 to determine if there are records for the user device identified in the request in flow 1. If not, records might be created. If there are records for that user device, the records would include details of one more motion audiences associated with the user device. An association of a user device (or some anonymized reference to the user device) might be formed form a history of motion of that user device. The mapping of users based on motion and other information to audiences might be done based on a stored set of rules that are stored in computer-readable form.

Based on previously gathered sensor data, a profile of the user of the user device is made. In flow 3, ad backend server 202 obtains audience segment data from the response to the query of user database 206 in flow 2. The reply data indicates the audience segments for the queried user ID. In flow 4, ad backend server 202 sends a message to user device 214 comprising an advertisement in the form of electronic content. This flow 4 appears to user device 214 as a response to the request in flow 1. Ad backend server 202 selects the ad to send based on processes that determine, based on campaign rules stored in computer-readable form that selects among possible ads and the one or more audiences that the user device belongs to. The message in flow 4 includes the advertisement content, which might be text, an animation, video, interactive program, etc. As an ad is provided to the user device, the user device will execute the code.

Once the advertisement message is received by user device 214, user device 214 can use the advertisement, such as by placing it into an advertising slot of the requesting app, or the like, and then the remainder of the process can be the same as with the ad exchange embodiment of FIG. 1.

The “ad result” data element might be a metric representing whether the ad was clicked on, which can be representative of, or a proxy for, a measure of engagement. The sensor data might be stored as a hash table that is then compiled into a protocol buffer or other data structure for serializing structured data. The sensor data data structure might be created by user device 214 using the SDK code along with information provided with the ad response.

Networked system 200 is similar to networked system 100, but in networked system 200, observed sensor data is collected separate from the delivered advertisement messages in flow 4. In this case, the motion data is already available at the user device, so it can be included in the ad request in flow 1. As shown, the SDK might be code supplied to app developers that would in turn support the ad request processes. Where the SDK code provides the functionality that monitors sensor data, the observed motion can be obtained without using an ad exchange server. The data and ad requests are directly transmitted between the device and the ad backend server. In the preferred embodiment, the motion data or other data is isolated from the published app, so that the app publisher does not have access to that data.

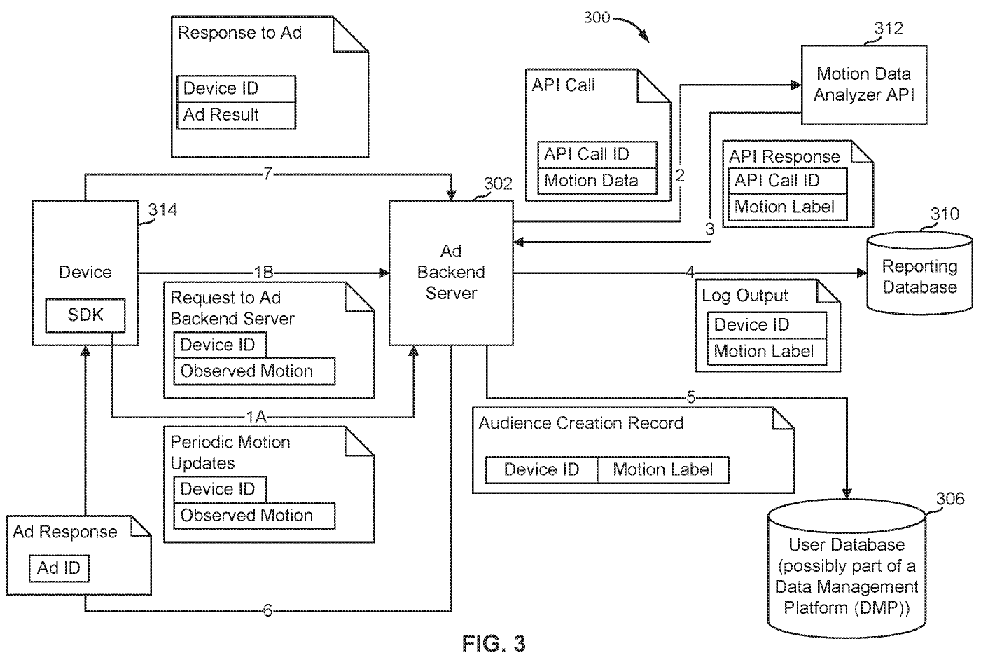

FIG. 3 illustrates another networked system 300, wherein program code observes motion data over a period of time that is used for selecting advertisements. Like the networked system of FIG. 2, embedded code gathers sensor data while the enabled app is running and provides that with an ad request is flow 1. However, in this variation, the user device stores sensor data over a period of time and then the SDK code sends data either with an ad request or without an ad request depending on the configuration. When data is sent without an ad request, it can be used to create audiences on the DMP and also to understand user behavior.

In the embodiment of FIG. 3, networked system 300 comprises an ad backend server 302, a user database 306, a reporting database 310 and a motion data analyzer 312, but user database 306 might only be used for storing created audience data. For getting ads, a published app might make a request to ad backend server 302 using code provided by an SDK for that purpose to the app developer. User device 314 executes the app that includes the SDK code. Although only one is shown, it should be understood that networked system 300 can handle many user devices simultaneously.

As in the other figures, the numbered arrows in FIG. 3 indicate flows wherein data elements are passed among the components of networked system 300. A process might start with flow 1A, where the app having the SDK code provides observed motion data and a device identifier to the ad backend server. Note that this occurs even prior to ads being delivered or requested, as the motion data functionality is provided by the SDK code provided to the app. Preferably, the motion data is gathered and sent without providing other areas of the app access to that data. In flow 1B, the motion data is provided by the SDK code in conjunction with an ad request.

With the app having the SDK code, that provides observed motion data and a device identifier to the ad backend server over an extended time period, and can be prior to any ads being delivered. This allows the ad backend server to determine the audience(s) of the user device prior to any ads being delivered, so that the first ad delivered can be to the correct audience. The data can be collected and the motion data and device ID sent on a regular cadence. The cadence need not be fixed and can vary based on a number of factors, such as availability of a channel to send the data.

Flows 2 and 3 in the embodiment of FIG. 3 operate similarly as the embodiment of FIG. 2. For flows 4 and 5, since there might not be an ad ID, those flows can use a device ID to match up the log outputs and audience creation records.

In the example shown in FIG. 3, the SDK code executed as part of the app transmits observed motion data to the ad backend server. As explained herein, the ad backend server uses that data to place the user device into one or more audiences and then uses those audiences to determine an ad to serve to the app when the app makes an ad request. In another variation, the app that transmits the observed motion data to the ad backend server need not be the same app that makes the ad request. For example, a first app might execute the SDK code and transmit observed motion data to the ad backend server. The ad backend server operates as before, but there might be a second app running on the user device that sends ad backend server an ad request. That second app need not include the SDK code, since the ad backend server already would have sufficient data from the first app. It also might be the case that the second app makes requests via an ad exchange, as in the example of FIG. 1. This is not difficult, since the second app is not being relied on to supply any observed motion data.

In the case where the user device is running more than one app with the SDK code, the ad backend server might process messages from more than one app on the user device. The ad backend server might receive identical data from more than one app on one user device, but the data might also not be identical. In such cases, the ad backend server could merge the multiple data sets, average them, use only the most recent data set, or perform other operations to deal with multiple sources of observed motion data observed from the same device.

According to one embodiment, the techniques described herein are implemented by one or generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

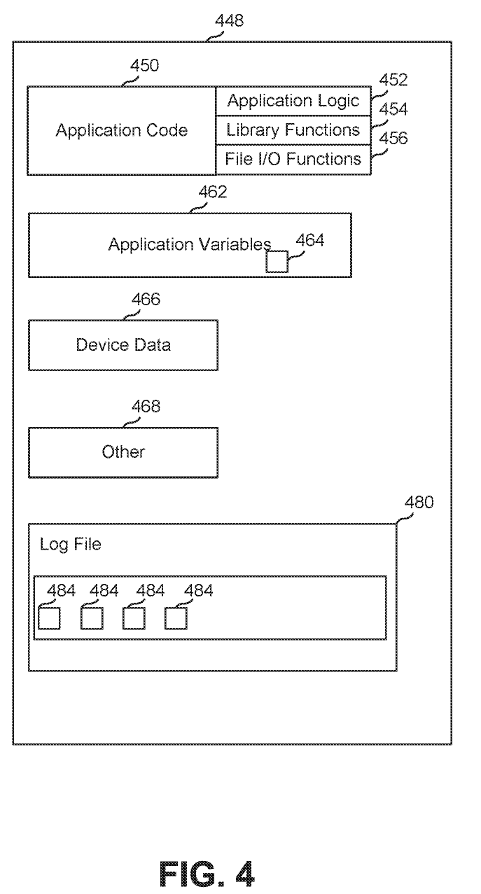

FIG. 4 illustrates an example of memory elements that might be used by a processor to implement elements of the embodiments described herein. For example, where a functional block is referenced, it might be implemented as program code stored in memory. FIG. 4 is a simplified functional block diagram of a storage device 448 having an application that can be accessed and executed by a processor in a computer system. The application can one or more of the applications described herein, running on servers, clients or other platforms or devices and might represent memory of one of the clients and/or servers illustrated elsewhere. Storage device 448 can be one or more memory devices that can be accessed by a processor and storage device 448 can have stored thereon application code 450 that can be configured to store one or more processor readable instructions. The application code 450 can include application logic 452, library functions 454, and file I/O functions 456 associated with the application.

Storage device 448 can also include application variables 462 that can include one or more storage locations configured to receive input variables 464. The application variables 462 can include variables that are generated by the application or otherwise local to the application. The application variables 462 can be generated, for example, from data retrieved from an external source, such as a user or an external device or application. The processor can execute the application code 450 to generate the application variables 462 provided to storage device 448.

One or more memory locations can be configured to store device data 466. Device data 466 can include data that is sourced by an external source, such as a user or an external device. Device data 466 can include, for example, records being passed between servers prior to being transmitted or after being received. Other data 468 might also be supplied.

Storage device 448 can also include a log file 480 having one or more storage locations 484 configured to store results of the application or inputs provided to the application. For example, the log file 480 can be configured to store a history of actions.

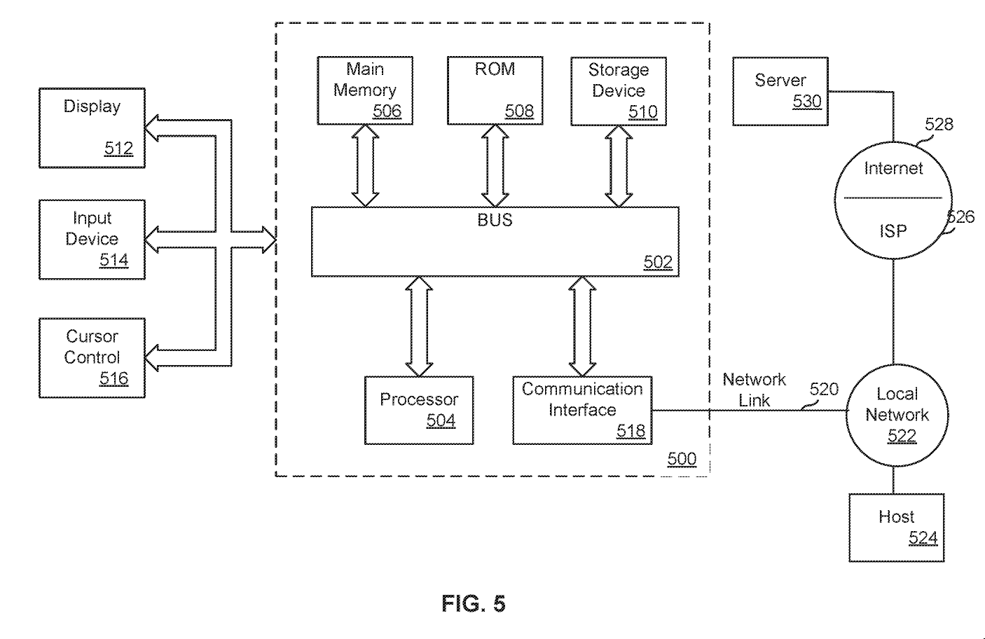

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a computer monitor, for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a network connection. A modem or network interface local to computer system 500 can receive the data. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method of serving advertisements to a user device having sensors that sense movement and other characteristics of the user device, the method comprising:
gathering sensor data from the user device;
analyzing the sensor data to determine a determined audience containing a user of the user device, wherein an audience is a collection of users sharing a determined profile;
selecting a selected advertisement to present to the user based on the determined audience of the user; and
following an advertisement request from an application executing on the user device, providing the selected advertisement to the application executing on the user device, wherein the determined audience is determined prior to providing the selected advertisement.

2. The method of claim 1, wherein analyzing the sensor data comprises:
mapping raw sensor data relating to motion of the user device into a motion label representing a presumed activity of the user while using the user device; and
using the motion label to select an audience for the user.

3. The method of claim 2, wherein analyzing the sensor data is performed using a machine learning process to interpret the sensor data and external data to determine a likely audience for the user of the user device.

4. The method of claim 1, wherein the determined audience is one of a plurality of audiences determined to include the user.

5. The method of claim 1, wherein determining the determined audience further comprises analyzing external data relating to the user of the user device or relating to the user device, wherein the external data indicates characteristics of a current environment of the user of the user device and/or of the user device itself other than characteristics determined from sensors of the user device.

6. The method of claim 5, wherein the external data includes one or more of weather data for a location indicated by a location sensor or program of the user device, map data indicative of a use of the location, or data indicative of a land type data of the location.

7. A non-transitory computer-readable storage medium having stored thereon executable instructions that, when executed by one or more processors of a computer system, cause the computer system to at least:
execute motion collection code in response to an application on a user device invoking the motion collection code;
record sensor data from sensors of the user device, wherein recording is done to a memory space not accessible to the application; and
transmit recorded sensor data to an ad backend server, wherein the recorded sensor data is transmitted without providing access to the recorded sensor data, in the clear, to the application.

8. The non-transitory computer-readable storage medium of claim 7, wherein the executable instructions are in the form of program code embedded into the application by way of a system development kit.

9. The non-transitory computer-readable storage medium of claim 7, wherein the executable instructions are in the form of program code embedded into an advertisement data message provided to the application in response to an advertisement request by the application.

10. The non-transitory computer-readable storage medium of claim 9, wherein the advertisement data message is in a JavaScript™ fragment delivered with the advertisement data message.

11. The non-transitory computer-readable storage medium of claim 10, wherein the JavaScript™ fragment is configured to pass through an ad exchange server that supplies advertisements to the user device.
